(19) United States
(12) Patent Application Publication
(10) Pub. No.: US 2010/0086770 A1
(43) Pub. Date: Apr. 8, 2010

(54) Laminates Comprising Metal Oxide Nanoparticles

(75) Inventor: Norbert Roesch, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/527,061

(22) PCT Filed: Feb. 13, 2008
(86) PCT No.: PCT/EP08/01082

§ 371 Date: Aug. 23, 2009

(30) Foreign Application Priority Data
Feb. 19, 2007 (DE) 10 2007 008 468.6
Feb. 13, 2008 (EP) PCT/EP2008/001082

(51) Int. Cl. B32B 5/16; B05D 7/00

(52) U.S. Cl. 428/329; 428/404; 428/405; 427/215

(57) ABSTRACT

The invention relates to laminates, which in the overlay preferably comprise metal oxide nanoparticles having a high percentage of α-Al₂O₃. These nanoparticles are preferably treated with a coating agent or stabilizer.

A multilayer thermosetting plastic which is formed by compression and adhesive bonding of at least two layers of identical or different materials is designated as a laminate. By combination, the properties of the individual materials can be supplemented.

The most usual laminates are from about 0.5 to 1.2 mm thick and, in the further processing, are generally applied to a substrate material (e.g. HDF boards or particle boards) using a special adhesive. The most frequent type of use for such laminate coatings is in laminate floors and kitchen worktops. However, laminates in thicknesses of from 2 to 20 cm can also be produced without problems. Such products designated as compact laminates are self-supporting with increasing thickness and are used, for example, in interior finishing but also in outdoor use as facade or balcony cladding. A laminate has many positive properties: the surface is tight and impact- and abrasion-resistant. It can be provided with various structures and is stable even at high temperatures for a short time without being damaged. The surface is easy to care for and to clean, heat- and light-stable and neutral in odor and insensitive to alcohol or organic solvents and the action of steam.

In the case of intended uses with a low surface load (e.g. in the case of kitchen fronts), the substrate boards with direct coating (two melamine resin-impregnated papers or a so-called finish film are pressed directly with the substrate material) are used. Owing to the smaller thickness of the surface coating, directly coated materials have a lower load-bearing capacity than materials coated with HPL or CPL. Today, the term laminate is often used as a synonym for laminate floors. Laminate floor is the combination of an HPL layer (high pressure laminate) or CPL layer (continuous pressure laminate), which is adhesively bonded to a substrate material (generally an HDF board).

In order to obtain a laminate board, a plurality of resin-impregnated papers are pressed with one another under pressure and with heating. Resins used are melamine-formaldehyde, phenol-formaldehyde, and urea-formaldehyde resins and combinations of these substances. For a high-quality decorative laminate, as used, for example, in the case of laminate floors, the following layers are used: the core consists of a plurality of phenol resin-impregnated papers, and the melamine resin-impregnated decorative layer is present on top. A so-called overlay which consists of two transparent melamine resin-impregnated papers, between which a corundum layer comprising coarse corundum (>20 μm) can be enclosed for stability reasons, is pressed on in the uppermost position. The use of overlays filled with corundum is also customary. A counteracting paper which reduces bending of the finished material is used on the underside. The coarse corundum has the function of protecting the decoration from abrasion and provides the required stability. In the case of a multilayer structure, a final layer is also generally employed, which final layer is not equipped with corundum, in order to protect the press plates and avoid roughness of the useful surface. The final overlay is therefore exposed in unprotected form to daily scratching.

WO 02/24446 describes laminates which comprise metal oxide particles for improving the scuff resistance. These metal oxide particles, which are prepared by the sol-gel process, have a particle diameter of from 5 to 70 microns and are therefore not nanoparticles.

It has now been found that the scratch resistance of the final overlay can be improved by incorporating nanocorundum.

The invention relates to laminates, preferably a laminate overlay, comprising metal oxide nanoparticles having a high proportion of α-alumina. Preferred nanoparticles which are used according to the invention are particles having a mean particle size in the range from 1 nm to 900 nm, preferably from 1 to 200 nm, and consist of oxides of elements of the 3^{rd} main group, in particular aluminum. The proportion of α-alumina is preferably in the range 50-100%. In the case of a content of less than 100% of Al₂O₃, the metal oxide nanoparticles also comprise further oxides as described further below, in addition to the α-Al₂O₃. It may also be advantageous to mix these metal oxide nanoparticles with alumina whose fineness is in the μm range, preferably <10 μm.

The nanoparticles are prepared by deagglomerating larger agglomerates which comprise these nanoparticles or consist thereof, in the presence of a dispersant with the use of suitable stabilizers. Such agglomerates are known per se and can be produced, for example, by the processes described below:

Coating materials comprising nanoparticles are known, the nanoparticles being prepared by means of the sol-gel technique by hydrolytic (co)condensation of tetraethoxysilane (TEOS) with further metal alkoxides in the absence of organic and/or inorganic binders. DE 199 24 644 discloses that the sol-gel synthesis can also be carried out in a medium. Radiation-curing formulations are preferably used. All materials prepared by means of the sol-gel process are, however, distinguished by low solids contents of inorganic and organic substance, by large amounts of condensate (as a rule alcohols), by the presence of water and by limited storage stability.

The high temperature-stable, reactive metal oxide particles prepared by hydrolytic condensation of metal alkoxides on the surface of nanoscale inorganic particles in the presence of reactive binders constitute progress. The thermal stability of the reacted formulations is achieved by the heterogeneous copolymerization of reactive groups of the medium with reactive groups of the same type of the binder. A disadvantage here is the incompleteness of the heterogeneous copolymerization, in which not all reactive groups enter into the copolymerization on the surface of the particles. This is mainly because of steric hindrances. However, it is known that the unreacted groups lead to undesired secondary reactions which can give rise to discolorations, embrittlement or premature degradation. This applies in particular to high temperature applications. The process described in DE 198 46 660 also leads to systems which are not storage-stable, owing to the acidic medium, in the presence of the condensate (as a rule alcohols).

Nanoscale surface-modified particles (Degussa Aerosil® R 7200), which have formed by condensation of metal oxides with silanes in the absence of a binder and hence in the absence of strong shear forces, as act in viscous media at stirring speeds of 10 m/s, are also known. For this reason, these aerosils have larger particles than the raw materials used, their opacity is substantially higher and their efficiency is lower than the effect of the particles described in WO 00/22052 and finishes prepared therefrom.

By various chemical syntheses, mostly precipitation reactions (hydroxide precipitation, hydrolysis of organometallic compounds) with subsequent calcination. In the preparation of pure α-alumina, crystallization nuclei are frequently added in order to reduce the transformation temperature. The sols thus obtained are dried and are converted into a gel. The further calcination then takes place at temperatures from 350° C. to 650° C. For the transformation into α-Al₂O₃, ignition must then be effected at temperatures of about 1000° C. The processes are described in detail in DE 199 22 492.

A further route is the aerosol process. There, the desired molecules are obtained from chemical reactions of a precursor gas or by rapid cooling of a supersaturated gas. The formation of the particles is effected either by collision or the vaporization and condensation of molecular clusters which take place continuously in equilibrium. The newly formed particles grow through further collision with product molecules (condensation) and/or particles (coagulation). If the coagulation rate is greater than that of the formation of new particles or of growth, agglomerates of primary spherical particles form.

Flame reactors constitute a preparation variant based on this principle. Here, nanoparticles are formed by the decomposition of precursor molecules in the flame at 1500° C.-2500° C. The oxidations of TiCl₄; SiCl₄ and Si₂O(CH₃)₆ in methane/O₂ flames, which lead to TiO₂ and SiO₂ particles, may be mentioned as examples. With the use of AlCl₃, it has been possible to date to produce only the corresponding alumina. Flame reactors are used today industrially for the synthesis of submicroparticles, such as carbon black, pigment TiO₂, silica and alumina.

Small particles can also be formed with the aid of centrifugal force, compressed air, sound, ultrasound and further methods, also from drops. The drops are then converted by direct pyrolysis or by in situ reactions with other gases into powders. Spray-drying and freeze-drying may be mentioned as known methods. In spray pyrolysis, precursor drops are transported through a high-temperature field (flame, oven), which leads to rapid vaporization of the readily volatile component or initiates the decomposition reaction to give the desired product. The desired particles are collected in filters. The preparation of BaTiO₃ from an aqueous solution of barium acetate and titanium lactate may be mentioned here as an example.

By milling, it is also possible to attempt to comminute coarse material and to produce crystallites in the nano range thereby. The best milling results can be achieved with stirred ball mills in a wet milling procedure. Grinding beads comprising a material which has a greater hardness than the mill base must be used in this case. In the case of the metal oxides to be used according to the invention, this route is, however, excluded owing to the great material hardness.

A further route for the preparation of corundum at low temperature is the conversion of aluminum chlorohydrate. This is likewise mixed with seeds, preferably comprising very fine corundum or hematite, for this purpose. For avoiding crystal growth, the samples must be calcined at temperatures around 700° C. to not more than 900° C. The duration of the calcination here is at least four hours. A disadvantage of this method is therefore the considerable time requirement and the residual amounts of chlorine in the alumina. The method was described in detail in Ber. DKG 74 (1997) No. 11/12, pages 719-722.

The nanoparticles must be liberated from these agglomerates. This is preferably effected by milling or by treatment with ultrasound. According to the invention, this deagglomeration is effected in the presence of a solvent and optionally of a coating material or stabilizer for modifying the surface, preferably of a silane or siloxane, which, during the milling process, saturates the resulting active and reactive surfaces by chemical reaction or physical accumulation and thus prevents reagglomeration. The nano oxide is retained as a small particle. It is also possible to add the coating material for the modification of the surface after deagglomeration is complete.

Preferably, agglomerates which are prepared according to the data in Ber. DKG 74 (1997) No. 11/12, pages 719-722, as described above, are used as starting material in the preparation of the metal oxide nanoparticles.

The starting point here is aluminum chlorohydrate, to which the formula Al₂(OH)ₓCl_{y} is ascribed, where x is a number from 2.5 to 5.5 and y is a number from 3.5 and 0.5 and the sum of x and y is always 6. This aluminum chlorohydrate is mixed as an aqueous solution with crystallization nuclei, then dried and then subjected to a thermal treatment (calcination).

About 50% strength aqueous solutions as are commercially available are preferably employed as starting material. Crystallization nuclei which promote the formation of the α-modification of Al₂O₃ are added to such a solution. In particular, such nuclei result in a reduction in the temperature for the formation of the α-modification in the subsequent thermal treatment. Preferred nuclei are very finely disperse corundum, diaspore or hematite. Particularly preferably, very finely disperse α-Al₂O₃ nuclei having a mean particle size of less than 0.1 μm are employed. In general, from 2 to 3% by weight of nuclei, based on the resulting alumina, are sufficient.

This starting solution may additionally comprise oxide formers in order to produce mixed oxides which comprise an oxide MeO. The chlorides of the elements of main groups I and II of the Periodic Table of the Elements and all further metals which form metal aluminates of the spinel type with alumina, such as, for example, zinc, magnesium, cobalt, copper, but also other soluble or dispersible salts, such as oxides, oxychlorides, carbonates or sulfates, are particularly suitable for this purpose. Furthermore, compounds which give oxides of rare earths (lanthanides) on calcination, such as, for example, salts of praseodymium, samarium, ytterbium, neodymium, lanthanum, cerium or mixtures thereof, can be added as oxide formers. Furthermore, it may be expedient to add oxide formers which give zirconium or hafnium oxide or mixtures of oxide formers, which give oxides of rare earths together with an oxide former for MgO. As a result of the addition of such oxide formers, further crystal lattices, for example garnet, spinel or magnetoplumbite lattices, form in addition to the corundum lattice. In this way, the corundum lattice is strengthened and better mechanical properties are achieved.

The amount of oxide former is such that the prepared nanoparticles preferably comprise from 0.01 to 50% by weight of the oxide Me. The oxides may be present as a separate phase alongside the alumina or may form genuine mixed oxides, such as, for example, spinels, etc., therewith.

The terms nanoparticle, nanocorundum and “mixed oxides” in the context of this invention are to be understood as meaning that both pure corundum and mixed corundum or genuine mixed oxides, such as, for example, the spinels, are meant thereby.

This suspension of aluminum chlorohydrate, nuclei and optionally oxide formers is then evaporated to dryness and subjected to a thermal treatment (calcination). This calcination is effected in apparatuses suitable for this purpose, for example in push-through, chamber, tubular, rotary-tube or microwave furnaces or in a fluidized-bed reactor. According to one variant of the process, it is also possible to adopt a procedure in which the aqueous suspension comprising aluminum chlorohydrate, nuclei and optionally oxide formers is sprayed directly into the calcination apparatus without prior removal of the water.

The temperature of the calcination should not exceed 1100° C. The lower temperature limit is dependent on the desired yield of nanocrystalline mixed oxide, on the desired residual chlorine content and on the content of nuclei. The formation of the nanoparticles begins at as low as about 500° C., but preferably from 700 to 1100° C., in particular from 1000 to 1100° C., is employed in order to keep the chlorine content low and the yield of nanoparticles high.

It has surprisingly been found that in general from 0.5 to 30 minutes, preferably from 0.5 to 10, in particular from 2 to 5, minutes are sufficient for the calcination. Even after this short time, sufficient yield of nanoparticles can be achieved under the abovementioned conditions for the preferred temperatures. However, calcination can also be effected, according to the data in Ber. DKG 74 (1997) No. 11/12, page 722, for 4 hours at 700° C. or for 8 hours at 500° C.

The nanoparticles must be liberated from these agglomerates which comprise the desired nanoparticles in the form of crystallites or consist thereof as a whole. This is preferably effected by milling or by treatment with ultrasound.

In order to obtain nanoparticles, the agglomerates are preferably comminuted by wet milling in a solvent, for example in an attritor mill, bead mill or stirred ball mill. Nanoparticles which have a crystallite size of less than 1 μm, preferably less than 0.2 μm, are obtained. Thus, for example after milling for 6 hours, a suspension of nanoparticles having a d90 value of about 90 nm is obtained. Another possibility for deagglomeration is the treatment with ultrasound. It may also be advantageous to deagglomerate the resulting agglomerates in a dissolver or similar mixing apparatus used in the coating industry.

If modification of the surface of these nanoparticles with coating materials, also referred to as stabilizers, such as, for example, silanes or siloxanes, is desired, there are two possibilities. According to the first preferred variant, the deagglomeration can be carried out in the presence of the coating material, for example by introducing the coating material into the mill during the milling. A second possibility consists in first destroying the agglomerates of the nanoparticles and then treating the nanoparticles, preferably in the form of a suspension in a solvent, with the coating material.

Suitable solvents for the deagglomeration are both water and customary solvents, preferably those which are also employed in the coating industry, such as, for example, C₁-C₄-alcohols, in particular methanol, ethanol or isopropanol, acetone, tetrahydrofuran, butyl acetate. If the deagglomeration is effected in water, an inorganic or organic acid, for example HCl, HNO₃, formic acid or acetic acid, should be added in order to stabilize the resulting nanoparticles in the aqueous suspension. The amount of acid may be from 0.1 to 5% by weight, based on the nanoparticles. For stabilization in the alkaline area, mixtures of polyacrylates/ammonia and citrates are preferably employed. If required, the nanoparticles in the acidic or alkaline suspensions can also be coated with further coating materials, preferably with silane or siloxane, if modification of the particle surface by such coating materials, also referred to as stabilizer, is desired. Preferably, silanes or siloxanes or mixtures thereof are suitable coating materials here.

In addition, all substances which can bind physically to the surface of the mixed oxides (adsorption) or which can bind to the surface of the mixed oxide particles by the formation of a chemical bond are suitable as coating materials. Since the surface of the mixed oxide particles is hydrophilic and free hydroxyl groups are available, suitable coating materials are alcohols, compounds having amino, hydroxyl, carbonyl, carboxyl or mercapto functions, silanes or siloxanes. Examples of such coating materials are polyvinyl alcohol, mono-, di- and tricarboxylic acids, amino acids, amines, waxes, surfactants, polymers, such as, for example, polyacrylates, hydroxycarboxylic acids, organosilanes and organosiloxanes.

Suitable silanes or siloxanes are compounds of the formulae:

R[—Si(R′R″)—O—]ₙSi(R′R″)—R″ or cyclo-[—Si(R′R″)—O—]ᵣSi(R′R″)—O— a)

in which
R, R′, R″, R′″—identical or different from one another, are an alkyl radical having 1-18 carbon atoms or a phenyl radical or an alkylphenyl or a phenylalkyl radical having 6-18 carbon atoms or a radical of the formula —CₘH₂ₘ—O)ₚ—C_{q}H_{2q+1} or a radical of the formula —CₛH₂ₛY or a radical of the formula —XZₜ₋₁,
n is an integer having the meaning 1≦n≦1000, preferably 1≦n≦100,
m is an integer 0≦m≦12 and
p is an integer 0≦p≦60 and
q is an integer 0≦q≦40 and
r is an integer 2≦r≦10 and
s is an integer 0≦s≦18 and
Y is a reactive group, for example α,β-ethylenically unsaturated groups, such as (meth)acryloyl, vinyl or allyl groups, amino, amido, ureido, hydroxyl, epoxy, isocyanato, mercapto, sulfonyl, phosphonyl, trialkoxysilyl, alkyldialkoxysilyl, dialkylmonoalkoxysilyl, anhydride and/or carboxyl groups, imido, imino, sulfite, sulfate, sulfonate, phosphine, phosphite, phosphate or phosphonate groups and
X is a t-functional oligomer where
t is an integer 2≦t≦8 and
Z in turn is a radical

R[—Si(R′R″)—O—]ₙSi(R′R″)—R′″ or cyclo-[—Si(R′R″)—O—]ᵣSi(R′R″)—O—

as defined above.

The t-functional oligomer X is preferably selected from:

oligoether, oligoester, oligoamide, oligourethane, oligourea, oligoolefin, oligovinyl halide, oligovinylidene halide, oligoimine, oligovinyl alcohol, ester, acetal or ether of oligovinyl alcohol, cooligomers of maleic anhydride, oligomers of (meth)acrylic acid, oligomers of (meth)acrylates, oligomers of (meth)acrylamides, oligomers of (meth)acrylimides, oligomers of (meth)acrylonitrile, particularly preferably oligoether, oligoester, oligo urethanes.

Examples of radicals of oligoethers are compounds of the type —(CₐH₂ₐ—O)_{b}—CₐH₂ₐ— or O—(CₐH₂ₐ—O)_{b}—CₐH₂ₐ—O where 2≦a≦12 and 1≦b≦60, e.g. a diethylene glycol, triethylene glycol or tetraethylene glycol radical, a dipropylene glycol, tripropylene glycol or tetrapropylene glycol radical, a dibutylene glycol, tributylene glycol or tetrabutylene glycol radical. Examples of radicals of oligoesters are compounds of the type —C_{b}H_{2b}—(C(CO)CₐH₂ₐ—(CO)O—C_{b}H_{2b}—)_{c}— or —O—C_{b}H_{2b}—(C(CO)CₐH₂ₐ—(CO)O—C_{b}H_{2b}—)_{c}—O— where a and b are different or identical and 3≦a≦12, 3≦b≦12 and 1≦c≦30, e.g. an oligoester obtained from hexanediol and adipic acid.

b) Organosilanes of the type (RO)₃Si(CH₂)ₘ—R′
R=alkyl, such as methyl, ethyl, propyl
m=0.1-20
R′=methyl, phenyl,
—C₄F₉; OCF₂—CHF—CF₃, —C₆F₁₃, —O—CF₂—CHF₂
—NH₂, —N₃, SCN, —CH═CH₂, —NH—CH₂—CH₂—NH₂,
—N—(CH₂—CH₂—NH₂)₂
—OOC(CH₃)C═CH₂
—OCH₂—CH(O)CH₂
—NH—CO—NH—CO—(CH₂)₅
—NH—COO—CH₃, —NH—COO—CH₂—CH₃, —NH—(CH₂)₃Si(OR)₃
—S_{χ}—(CH₂)₃)Si(OR)₃
—SH
—NR′R″R′″ (R′=alkyl, phenyl; R″=alkyl, phenyl; R′″=H, alkyl, phenyl, benzyl, C₂H₄NR″″ where R″″=A, alkyl and R′″″=H, alkyl).

Examples of silanes of the above-defined type are, for example, hexamethyldisiloxane, octamethyltrisiloxane, further homologous and isomeric compounds of the series SiₙOₙ₋₁ (CH₃)₂ₙ₊₂, in which
n is an integer 2≦n≦1000, e.g. polydimethylsiloxane 200® fluid (20 cSt).

Hexamethylcyclotrisiloxane, octamethylcyclotetrasiloxane, preferably homologous and isomeric compounds of the series

(Si—O)ᵣ(CH₃)₂ᵣ, in which
r is an integer 3≦r≦12,
dihydroxytetramethyldisiloxane, dihydroxyhexamethyltrisiloxane, dihydroxyoctamethyltetrasiloxane, further homologous and isomeric compounds of the series
HO—[(Si—O)ₙ(CH₃)₂ₙ]—Si(CH₃)₂—OH or
HO—[(Si—O)ₙ(CH₃)₂ₙ]—[Si—Oₘ(C₆H₅)₂ₘ]—Si(CH₃)₂—OH, in which
m is an integer 2≦m≦1000;
the α,ω-dihydroxypolysiloxanes, e.g. polydimethylsiloxane (OH terminal groups, 90-150 cST) or polydimethylsiloxane-co-diphenylsiloxane (dihydroxy terminal groups, 60 cST), are preferred.

Dihydrohexamethyltrisiloxane, dihydrooctamethyltetrasiloxane, further homologous and isomeric compounds of the series

H—[(Si—O)ₙ(CH₃)₂ₙ]—Si(CH₃)₂—H, in which
n is an integer 2≦n≦1000; the α,ω-dihydropolysiloxanes, e.g. polydimethylsiloxane (hydride terminal groups, Mₙ=580), are preferred.

Di(hydroxypropyl)hexamethyltrisiloxane, di(hydroxypropyl)octamethyltetra-siloxane, further homologous and isomeric compounds of the series

HO—(CH₂)ᵤ[(Si—O)ₙ(CH₃)₂(CH₂)ᵤ—OH; the α,ω-dicarbinolpolysiloxanes with 3≦u≦18, 3≦n≦1000 or their polyether-modified successor compounds based on ethylene oxide (EO) and propylene oxide (PO) as homo- or copolymer HO-(EO/PO)ᵥ—(CH₂)ᵤ[(Si—O)ₜ(CH₃)₂ₜ]—Si(CH₃)₂(CH₂)-(EO/PO)ᵥ—OH are preferred; α,ω-di(carbinolpolyether)polylsiloxanes with 3≦n≦1000, 3≦u≦18, 1≦v≦50 are preferred.

Instead of α,ω-OH groups, the corresponding difunctional compounds having epoxy, isocyanato, vinyl, allyl and di(meth)acryloyl groups are likewise used, e.g. polydimethylsiloxane having terminal vinyl groups (850-1150 cST) or TEGORAD® 2500 from Tego Chemie Service.

The esterification products of ethoxylated/propoxylated trisiloxanes and higher siloxanes with acrylic acid copolymers and/or maleic acid copolymers as a modifying compound are also suitable, e.g. BYK Silclean® 3700 from Byk Chemie or TEGO® Protect 5001 from Tego Chemie Service GmbH.

Instead of α,ω-OH groups, the corresponding difunctional compounds having —NHR″″ where R″″=H or alkyl are likewise used, for example the generally known aminosilicone oils from Wacker, Dow Corning, Bayer, Rhodia, etc. are used, which carry on their polymer chain (cyclo)alkylamino groups or (cyclo)alkylimino groups distributed randomly over the polysiloxane chain.

c) Organosilanes of the type (RO)₃Si(CₙH₂ₙ₊₁) and (RO)₃Si(CₙH₂ₙ₊₁), in which
R is an alkyl, such as, for example, methyl, ethyl, n-propyl, isopropyl, butyl
n is from 1 to 20.

Organosilanes of the type R′x(RO)ySi(CnH2n+1) and (RO)3Si(CnH2n+1), in which
R is an alkyl, such as, for example, methyl, ethyl, n-propyl, isopropyl, butyl
R′ is an alkyl, such as, for example, methyl, ethyl, n-propyl, isopropyl, butyl
R′ is a cycloalkyl
n is an integer from 1-20
x+y is 3
x is 1 or 2
y is 1 or 2.
   d) Organosilanes of the type (RO)₃Si(CH₂)ₘ—R′, in which
R is an alkyl, such as, for example, methyl, ethyl, propyl
m is a number from 0.1 to 20
R′ is methyl, phenyl, —C₄F₉; OCF₂—CHF—CF₃, —C₆F₁₃, —O—CF₂—CHF₂, —NH₂—, —N₃, —SCN, —CH═CH₂, —NH—CH₂—CH₂—NH₂, —N—(CH₂—CH₂—NH₂)₂, —OOC(CH₃)C═OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃)Si(OR)₃, —SH—NR′R″R′″ (R′=alkyl, phenyl; R″=alkyl, phenyl; R′″=H, alkyl, phenyl, benzyl, C₂H₄NR″″R′″″ where R″″=H, alkyl and R′″″=H, alkyl).

Preferred silanes are the silanes mentioned below:

triethoxysilane, octadecyltrimethoxysilane, 3-(trimethoxysilyl)propyl methacrylates, 3-(trimethoxysilyl)propyl acrylates, 3-(trimethoxysilyl)methyl methacrylates, 3-(trimethoxysilyl)methyl acrylates, 3-(trimethoxysilyl)ethyl methacrylates, 3-(trimethoxysilyl)ethyl acrylates, 3-(trimethoxysilyl)pentyl methacrylates, 3-(trimethosysilyl)pentyl acrylates, 3-(trimethoxysilyl)hexyl methacrylates, 3-(trimethoxysilyl)hexyl acrylates, 3-(trimethoxysilyl)butyl methacrylates, 3-(trimethoxysilyl)butyl acrylates, 3-(trimethoxysilyl)heptyl methacrylates, 3-(trimethoxysilyl)heptyl acrylates, 3-(trim ethoxysilyl)octyl methacrylates, 3-(trimethoxysilyl)octyl acrylates, methyltrimethoxysilanes, methyltriethoxysilanes, propyltrimethoxysilanes, propyltriethoxysilanes, isobutyltrimethoxysilanes, isobutyltriethoxysilanes, octyltrimethoxysilanes, octyltriethoxysilanes, hexadecyltrimethoxysilanes, phenyltrimethoxysilanes, phenyltriethoxysilanes, tridecafluoro-1,1,2,2-tetra-hydrooctyltriethoxysilanes, tetramethoxysilanes, tetraethoxysilanes, oligomeric tetraethoxysilanes (DYNASIL® 40 from Degussa), tetra-n-propoxysilanes, 3-glycidyloxypropyltrimethoxysilanes, 3-glycidyloxypropyl-triethoxysilanes, 3-methacryloyloxypropyltrimethoxysilanes, vinyl-trimethoxysilanes, vinyltriethoxysilanes, 3-mercaptopropyltrimethoxy-silanes, 3-aminopropyltriethoxysilanes, 3-aminopropyltrimethoxysilanes, 2-aminoethyl-3-aminopropyltrimethoxysilanes, triamino-functional propyl-trimethoxysilanes (DYNASYLAN® TRIAMINO from Degussa), N-(n-butyl-3-aminopropyltrimethoxysilanes, 3-aminopropylmethyldiethoxysilanes.

The coating materials, here in particular the silanes or siloxanes, are preferably added in molar nanoparticle-to-silane ratios of from 1:1 to 500:1. The amount of solvent in the deagglomeration is in general from 50 to 90% by weight, based on the total amount of nanoparticles and solvent.

The deagglomeration by milling and simultaneous modification with the coating material is preferably effected at temperatures of from 20 to 150° C., particularly preferably at from 20 to 90° C.

If the deagglomeration is effected by milling, the suspension is then separated from the grinding beads.

After the deagglomeration, the suspension can be heated for up to 30 hours for completing the reaction. Finally, the solvent is distilled off and the remaining residue is dried. It may also be advantageous to leave the optionally modified mixed oxide nanoparticles in the solvent and to use the dispersion for further applications.

It is also possible to suspend the nanoparticles in the corresponding solvents and to carry out the reaction with the coating material after the deagglomeration in a further step.

It is also possible to use combinations of adsorbed substances and chemically fixed substances, such as, for example, silanes. With the use of aminosilanes, the coated nanoparticles can be reacted with the coating resins and thus chemically fixed.

The nanoparticles thus prepared and optionally modified on the surface are incorporated into such coating materials, such as, for example, formaldehyde-melamine; formaldehyde-urea; formaldehyde-phenol and combinations of these resins, as are customary for the production of laminate boards. This addition of the nanoparticles in the production of laminates is preferably effected in such a way that a dispersion of the nanoparticles in the aqueous phase is added to the impregnating resins for the production of the laminates, and the laminates are then completed in a manner known per se.

It is preferable here if the nanoparticles are incorporated into the so-called overlay, especially in the final overlay, of laminate boards.

The coating materials according to the invention can moreover comprise further additives, as are customary in the case of laminate boards, for example reactive diluents, solvents and cosolvents, waxes, dulling agents, lubricants, antifoams, deaerating agents, leveling agents, thixotropic agents, thickeners, inorganic and organic pigments, fillers, adhesion promoters, corrosion inhibitors, corrosion protection pigments, UV stabilizers, HALS compounds, free radical scavengers, antistatic agents, wetting agents and dispersants and/or the catalysts, cocatalysts, initiators, free radical formers, photoinitiators, photosensitizers, etc. necessary depending on the method of curing. Suitable further additives are also polyethylene glycol and other water retention agents, PE waxes, PTFE waxes, PP waxes, amide waxes, FT paraffins, montan waxes, grafted waxes, natural waxes, macro- and microcrystalline paraffins, polar polyolefin waxes, sorbitan esters, polyamides, polyolefins, PTFE, wetting agents or silicates.

The subject according to the invention is to be illustrated in more detail with reference to the following examples, without limiting the possible variety.

### EXAMPLES

### Example 1

Magnesium chloride was added to a 50% strength aqueous solution of aluminum chlorohydrate so that, after the calcination, the ratio of aluminum oxide to magnesium oxide was 99.5:0.5%. In addition, 2% of crystallization nuclei of a suspension of very fine corundum were added to the solution. After the solution was homogenized by stirring, drying is effected in a rotary evaporator. The solid aluminum chlorohydrate/magnesium chloride mixture was comminuted in a mortar, a coarse powder forming.

The powder was calcined in a rotary tube furnace at 1050° C. The contact time in the hot zone was not more than 5 min. A white powder whose particle distribution corresponded to the feed was obtained.

An X-ray structure analysis shows that predominantly α-alumina is present.

The scanning electron micrographs (scanning electromicroscope) showed crystallites in the range 10-80 nm (estimation from scanning electron micrograph) which are present as agglomerates. The residual chlorine content was only a few ppm.

In a further step, 100 g of this corundum powder doped with magnesium oxide were suspended in 100 g of water. 1 g of ammonium acrylate polymer (Dispex® N, Ciba) was added to the suspension and the suspension was fed to a vertical stirred ball mill from Netzsch (type PE 075). The grinding beads used consisted of zirconium oxide (stabilized with yttrium) and had a size of 0.3 mm. After three hours, the suspension was separated from the grinding beads.

### Example 2

Magnesium chloride was added to a 50% strength aqueous solution of aluminum chlorohydrate so that, after the calcination, the ratio of aluminum oxide to magnesium oxide was 99.5:0.5%. In addition, 2% of crystallization nuclei of a suspension of very fine corundum were added to the solution. After the solution was homogenized by stirring, drying is effected in a rotary evaporator. The solid aluminum chlorohydrate/magnesium chloride mixture was comminuted in a mortar, a coarse powder forming.

The powder was calcined in a rotary tube furnace at 1050° C. The contact time in the hot zone was not more than 5 min. A white powder whose particle distribution corresponded to the feed was obtained.

An X-ray structure analysis shows that predominantly α-alumina is present.

The scanning electron micrographs (scanning electromicroscope) showed crystallites in the range 10-80 nm (estimation from scanning electron micrograph) which are present as agglomerates. The residual chlorine content was only a few ppm.

In a further step, 100 g of this corundum powder doped with magnesium oxide were suspended in 100 g of water. 1 g of ammonium acrylate polymer (Dispex N, Ciba) and 0.5 g of trimethoxyaminopropylsilane (Dynasilan Ammo) were added to the suspension and the suspension was fed to a vertical stirred ball mill from Netzsch (type PE 075). The grinding beads used consisted of zirconium oxide (stabilized with yttrium) and had a size of 0.3 mm. After three hours, the suspension was separated from the grinding beads.

### Example 3

Zinc chloride was added to a 50% strength aqueous solution of aluminum chlorohydrate so that, after the calcination, the aluminum oxide-to-zinc oxide ratio is 50:50. After the solution was homogenized by stirring, drying is effected in a rotary evaporator. The solid aluminum chlorohydrate/zinc chloride mixture was comminuted in a mortar, a coarse powder forming.

The powder was calcined in a rotary tube furnace at 850° C. The contact time in the hot zone was not more than 5 min. A white powder whose particle distribution corresponded to the feed was obtained.

An X-ray structure analysis showed that it is zinc spinel. The residual chlorine content is below 100 ppm. The high-resolution scanning electronmicrographs (scanning electron microscopy) show crystallites of <10 nm which are present in agglomerated form.

In a further step, 40 g of zinc spinel were suspended in 160 g of water. The suspension was deagglomerated in a vertical stirred ball mill from Netzsch (type PE 075). The grinding beads used consisted of zirconium oxide (stabilized with yttrium) and had a size of 0.3 mm. During the milling, 0.5 g of ammonium acrylate (Dispex N; Ciba) and 0.3 g of trimethoxyamino-propylsilane (Dynasilan Ammo) were added over the entire duration of the deagglomeration. After 6 hours, the suspension was separated from the grinding beads and characterized with regard to particle distribution with the aid of an analytical disk centrifuge from Brookhaven. A d90 of 55 nm was found.

### Example 4

A suspension of very fine corundum nuclei (2%, based on Al2O3), 5.2 g of yttrium nitrate and 4 g of lanthanum nitrate were added to 500 g of a 50% strength aqueous solution of aluminum chlorohydrate. After the solution was homogenized by stirring, drying is effected in a rotary evaporator. The solid aluminum chlorohydrate/salt mixture was comminuted in a mortar, a coarse powder forming.

The powder was calcined in a muffle furnace at 1100° C. The contact time was about 30 min. A white powder whose particle distribution corresponded to the feed was obtained.

An X-ray structure analysis showed that it is corundum through which the phases of the corresponding mixed oxides pass. The high-resolution scanning electron micrographs (scanning electron microscopy) show lamellar intergrowths of the corundum crystallites present in excess.

In a further step, 40 g of the corundum strengthened by foreign phases were suspended in 160 g of water. The suspension was deagglomerated in a vertical stirred ball mill from Netzsch (type PE 075). The grinding beads used consisted of zirconium oxide (stabilized with yttrium) and had a size of 0.3 mm. During the milling, 0.5 g of ammonium acrylate (Dispex N; Ciba) and 0.3 g of trimethoxyaminopropylsilane (Dynasilan Ammo) were added over the entire duration of the deagglomeration. After 6 hours, the suspension was separated from the grinding beads and characterized with regard to particle distribution with the aid of an analytical disk centrifuge from Brookhaven. A d90 of 55 nm was found.

### Use Examples

The coated nanoparticles from examples 1 to 3 were mixed with impregnating resins (dissolver) and the mixtures were used for coating printed decorative paper. For the experiments, the melamine resin Madurit® MW 550 (Ineos Melamines) was used. After drying of the impregnation, the lamination of the decorative papers with substrate boards was effected in a hot press at 150° C. and a pressure of 200 bar. The duration of pressing was 4 min.

The finished laminate pieces (40 cm*40 cm) were tested with regard to their scratch resistance by means of a diamond stylus (Eriksen test). The higher the contact force of the diamond stylus, the better the scratch resistance.

The following measured values were determined:

| | | Reference sample | | | |
|---|---|---|---|---|---|
| | Refer- | +3% of | +3% of | +3% of | +3% of |
| | ence | nanoparticles | nanoparticles | nanoparticles | nanoparticles |
| | sample | (Example 1) | (Example 2) | (Example 3) | (Example 4) |
| Con- | 3.5 N | 4.3 N | 5.0 N | 4.5 N | 5.2 N |
| tact | | | | | |
| force | | | | | |

1. A laminate comprising metal oxide nanoparticles, wherein the nanoparticles are modified on the surface with a stabilizer and have high proportion of α-alumina.

2. The laminate as claimed in claim 1, wherein the nanoparticles comprise up to 50% by weight of a further oxide, wherein mixtures or genuine solid solutions are present.

3. A laminate comprising metal oxide nanoparticles having a mean particle size of from 1 nm to 900 nm and an α-alumina content of 50-100%, wherein the metal oxide nanoparticles are modified on the surface with a stabilizer.

4. The laminate as claimed in claim 1, wherein the metal oxide nanoparticles are modified on the surface with a silane or siloxane or mixtures thereof as a stabilizer.

5. A laminate comprising metal oxide nanoparticles having a high proportion of α-alumina, wherein the nanoparticles comprise up to 50% by weight of a further oxide from the series consisting of the rare earths or zirconium or hafnium.

6. The laminate as claimed in claim 1, which additionally comprises alumina having a fineness in the μm range.

7. The laminate as claimed in claim 1, wherein the metal oxide nanoparticles are present in the overlay.

8. A process for the production of laminates, comprising the steps of mixing a dispersion of nanoparticles having a high proportion of α-alumina in a solvent, with an impregnating resin for the production of laminates, and completing the laminate in the usual manner.

9. A process as claimed in claim 8, wherein the solvent is water.
